(19) United States
(12) Patent Application Publication
(10) Pub. No.: US 2006/0075249 A1
(43) Pub. Date: Apr. 6, 2006

(54) Electromagnetic security device

(76) Inventor: Ralph E. Hayes, Greenville, SC (US)

Correspondence Address: MCNAIR LAW FIRM, P.A., P.O. BOX 10827, GREENVILLE, SC, 29603-0827, US

(21) Appl. No.: 10/957,856

(22) Filed: Oct. 4, 2004

(51) Int. Cl. H04L 9/00

(52) U.S. Cl. 713/179

(57) ABSTRACT

This invention is directed to a security thread having electromagnetic properties allowing the thread to have an electromagnetic signature. By using an electromagnetic scanner, the electromagnetic signature of the security thread can be read and compared with an authentication value so that if the values match, the thread is authentic. By associating the security thread with a product, the authenticity of the product can be verified with this invention.

### FIELD OF THE INVENTION

This invention is directed toward an electromagnetic security device and more specifically to a security thread having unique electromagnetic properties so as to be able to be scanned and a determination made as to whether the security thread has a particular electronic signature for authenticating items associated with the security thread.

### BACKGROUND OF THE INVENTION

It has long been a challenge to combat counterfeiters in the marketplace. This challenge appears most notably in currency, but can also extend to many other items such as clothing, women's accessories, sports equipment, and other items. Particularly, manufacturers of goods have specific quality control and marketing efforts associated with their goods that they wish to protect. Counterfeit products are of particular concern since such goods undermine the quality, reputation, and market for legitimate products.

In order to insure that products are genuine and not counterfeit, there have been several means developed to identify genuine goods. For example, U.S. currency contains an ink strip embedded in the paper that contains lettering that identifies the amount of the currency. Women's purses and accessories include leather, cloth, or other tags that have specific insignia attached to the article to identify its authenticity. Holographic labels have also been permanently affixed to goods. Other identification means include symbols, logos, and indentions, so that the presence of such indicia represent that a product is genuine. However, the traditional methods of identifying these items, while being low cost, typically are physical and visual in nature and are therefore more susceptible to counterfeiting.

Accordingly, there is a need for an identification device that indicates authenticity and genuineness that does not necessarily rely upon visual observations easily duplicated.

Accordingly, it is an object of this invention to provide an indicator to represent genuineness that does not rely upon visual observation.

It is yet another object of this invention to provide a security indicator that is of a size so that it can be embedded or incorporated in a product rather than attached or secured to a product.

### DESCRIPTION OF THE DRAWINGS

This invention will be understood by referring to the following drawings:

FIG. 1 is a cross-section of the invention;

FIG. 2 is a side view of the invention; and,

FIG. 3 is a side view of the invention.

### SUMMARY OF THE INVENTION

A security thread containing a center insulation thread with a first conductive thread twisted about the center insulation thread. The thread also contains a second conductive thread twisted about the center insulation thread so that the second conductive thread is not in physical conduct with the first conductive thread thereby producing a security thread having a unique electromagnetic signature representing the different conductive thread resistance points along the upper portion of the cross-section of the security thread. The thread may also contain a plurality of insulators wrapped around the center insulating thread arranged between the first conductive thread and the second conductive thread. The first conductive thread and the second conductive thread are twisted around the center insulating thread at 3.375 turns per inch. The threads may be a first color for the first conductive thread, and a second color optically distinguishable from the first color for the second conductive thread. The first conductive thread may be made of conductive material from the group, carbon, gold or silver. The thread may contain a third conductive thread twisted around the center insulation thread. The thread may include a plurality of insulating threads wrapped around the center insulating thread and arranged between the first conductive thread, the second conductive thread, and the third conductive thread. The first conductive thread, the second conductive thread, and the third conductive thread are twisted around the center conductive thread at 3.375 turns per inch. The first conductive thread may produce a frequency of greater or equal to 531.44107 KHz. The first conductive thread may produce a frequency of less or equal to 531.44092 KHz.

A system for authenticating security threads having an electromagnetic probe for scanning a security thread, a computer readable medium in communication with the electromagnetic probe, an authentication number stored in the computer readable medium, and, a set of computer readable instructions embodied in the computer readable medium. The set of instructions are for receiving electromagnetical information from the electromagnetic probe, converting the electromagnetic information into a number representing the security thread, comparing the number with the authentication number, and providing notification if the number and the authentication number match. The authentication number may be stored in an encrypted form; and, the computer readable instructions include instructions to decrypt the authentication number. The encrypted authentication number may be encrypted with a root key of 369.0563. The computer readable instructions may include instructions for converting a frequency equal to or greater than 531.44107 KHz to the binary representation one and for converting a frequency equal to or less than 531.44092 KHz to the binary representation zero.

### DETAILED DESCRIPTION OF A PREFERRED EMBODIMENT

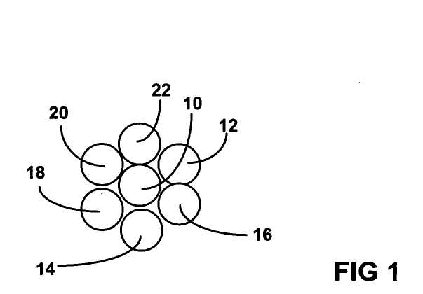

Referring now to FIG. 1, a central insulating thread 10 is shown forming the core of the security thread. A first conductive thread 12 is shown wrapped around central insulating thread 10 and separated from a second conductive thread 14 by an insulating thread 16. An insulating thread 18 separates the second conductive thread from the third conductive thread 20 which is then separated from the first conductive thread by an insulating thread 22. Based upon this configuration, you can see that the conductive threads are alternating between insulating threads and are wrapped around a central insulating thread. The conductive threads can be formed from conductive materials such as carbon, gold, or silver. Due to the fact that each of these materials have different electromagnetic properties, each one of the conductive threads also exhibits different resistance properties and electromagnetic frequencies. When current is applied to the conductive threads, it can be determined what electromagnetic energy is being radiated by the thread. As well known in the art of electromagnetisms, the induction of a current through a conductive material will travel in a linear fashion along the material and will also produce an electromagnetic field around the conductive material. By having different conductive threads, different resistance and electromagnetic properties will be exhibited by each of the threads when current is applied to the security thread. This can be measured by an electromagnetic scanner and an electronic signature can be read from the security thread.

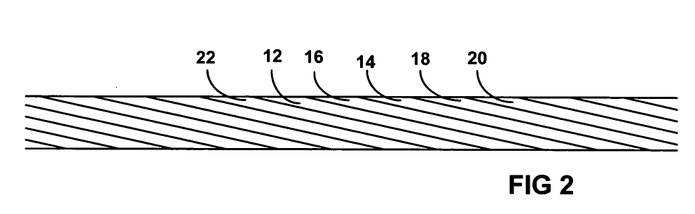

Referring now to FIG. 2, a side view of the security thread is shown. In the preferred embodiment, the threads are twisted about the center insulating thread at 3.375 turns per inch. Therefore, the conductive threads and insulating threads create alternating portions that are present on the topmost portion of the security thread when viewed in the direction shown generally as A. As such, the measurement of electromagnetic energy resulting from a current being placed on the thread provides a different electromagnetic reading based upon the different conductive material and insulators in the alternating position as the scanner moves along direction A.

It should also be noted that each of the conductive threads can be a different color. Therefore, the first conductive thread, second conductive thread, third conductive thread, may have unique optical properties that could be read visually so as also to determine whether the particular thread being viewed and such determinations can be associated with the electromagnetic properties.

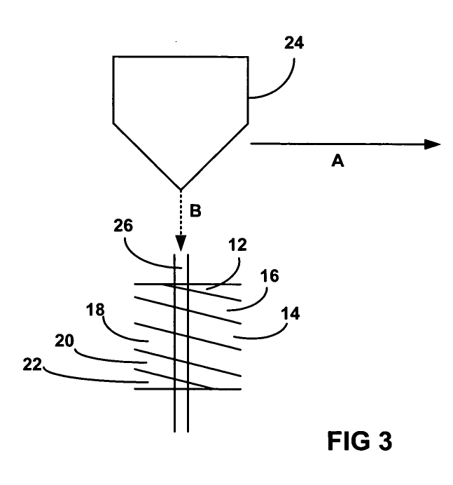

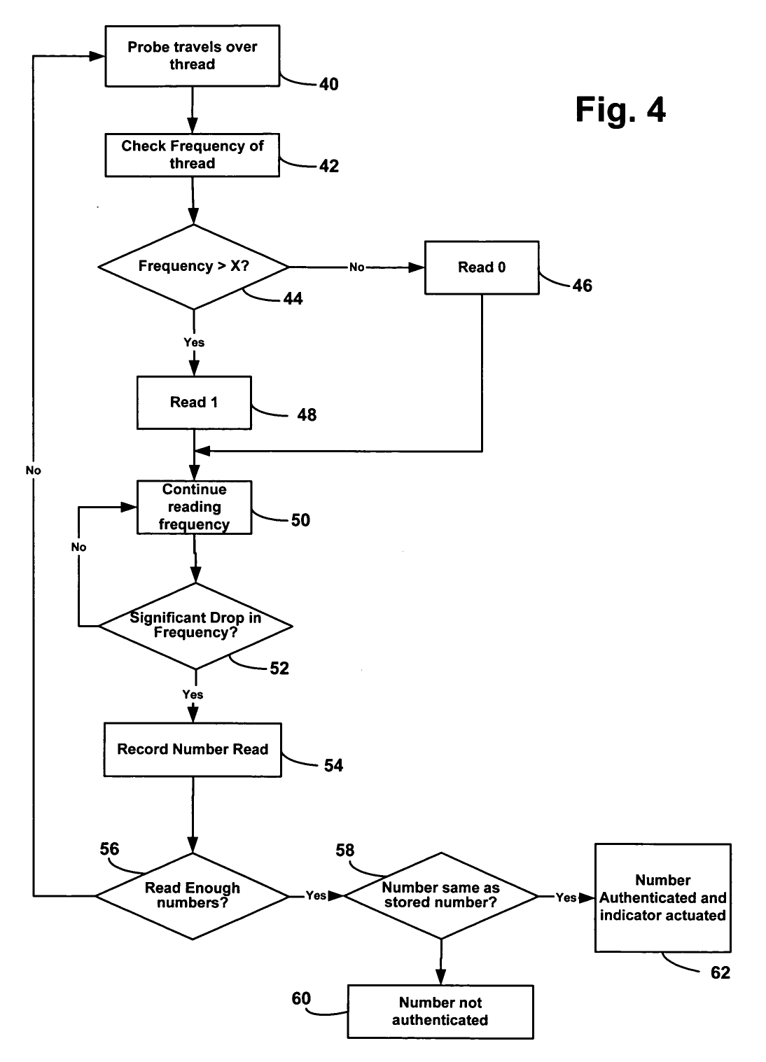

Referring now to FIG. 3, the invention is shown in combination with a scanner. A scanner 24 is shown that reads a cross-section area 26 of the security thread of the uppermost portion. In this example, the first conductive thread 12 is being read by the scanner while the scanner is traveling in a direction shown generally as B. When the scanner travels in this direction, it scans the topmost portion of the cross-section of the security thread. As the scanner transverses down the thread, it picks up the resistive or electromagnetic energy emanating from the particular conductive material at the topmost portion of the cross-section and provides an electronic signature that can be used to determine if the thread has the proper electromagnetic pulse.

The scanner, such as an electromagnetic scanner, can determine the frequency of electromagnetic energy emanating from the conductive threads. The scanner can be calibrated so that if the scanner determines that the frequency emitting from a conductive thread is greater than 531.44107 KHz (531,441.07 Hz), the thread can be considered “positive” while 531.44092 KHz (531,440.92 Hz) can be considered “negative.” As the scanner passes in direction A, the threads can be read and converted from Hz to binary so that conductive threads greater than 531.44107 KHz are represented by “1” while conductive threads of less than 531.44092 KHz are represented by “0.” Therefore, with three conductive threads, possible values are 111, 110, 101, 011, 100, 010, 001, and 000. These values can be used to establish that the security thread is authentic.

Additionally, these binary codes, and even the actual frequency measurements from the thread themselves, can be encrypted so as not to be easily discernable from reading the thread. For example, the “authorized” thread may be represented by the binary representation of “101.” Therefore, the scanner will need to understand that the proper reading from the security thread is “101.” In order to protect this information stored or accessible to the scanner, the “101” can be encrypted through various means known in the art. For example, a root key can be used to encrypt the compared number “101.” An example of a root key is 369.0563 which is also a consonant value when viewed with the 3.375 turns per inch of the preferred embodiment and the values associated with the “1” and “0” designations.

The electromagnetic scanner can be operated with software. Software resides in a computer readable medium and is in communication with an electromagnetic probe. When the probe is in proximity to the top portion of the security thread, the resistance, frequency, optical or other electromagnetic properties are read and transmitted to the computer readable medium. Various readings can be stored in the computer readable medium so that as the probe travels along the thread, the computer readable instructions can receive the readings from the probe, determine when a change in readings occurs, store the previous and current values being read, aggregate the readings to determine a series of readings, convert the reading to numeric format and compare the numeric format with an authentication value to determine if the security thread is authentic.

The present invention is described with reference to flowchart illustrations of methods, apparatus (“systems”), or computer program products according to the invention. It will be understood that each block of a flowchart illustration may be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions. The present invention is now described more fully herein with reference to the drawings in which the preferred embodiment of the invention is shown. This invention may, however, be embodied any many different forms and should not be construed as limited to the embodiment set forth herein. Rather, these embodiments are provided so that this disclosure will be thorough and complete and will fully convey the scope of the invention to those skilled in the art.

Referring now to FIG. 4, the operation of the probe is described in more detail. As the probe travels over the thread at step 40, it will encounter a first segment of the thread. At step 42, the probe will check the frequency of the thread. If the frequency is greater than a predetermined number X at step 44, then the probe will read a binary 1 for this frequency. Otherwise at step 46 the probe will read a binary 0. Note that a wide variety of numbers can be used for this determination. The frequency represented by X may be equal to 531.44107 KHz. The frequency may also be equal to 531.44092 KHz. The value X may also represent a range including both of the above listed numbers, meaning that any frequency in between those two numbers will not register a 1 or a 0. Upon associating the frequency read with either a 1 or a 0, the probe continues reading the frequency from the thread at step 50. If, at step 52, there is a significant drop in the frequency then at step 54 the number read is recorded by the probe. If no significant drop in frequency occurs at step 52, then the probe continues to read the frequency off the thread at step 50. The significant drop in frequency represents a moving from the current conductive thread to an insulated thread which in turn will mean the next thread to be read will come after the insulated thread. If at step 56 enough numbers have been read to authenticate the thread, the system will authenticate the thread. If not, then the system returns to step 40 and continues the process until enough numbers have been read at step 56. Once enough numbers have been read, the probe will determine if the number read is the same as the stored number at step 58. Note that as described above, the stored number may be encrypted with a specialized root key for security measures. If the number is the same as the stored number, then at step 62 the thread is authenticated and an indicator is actuated to inform the user that the thread is authentic. Such an indicator could be a light, audible member, tactile indicator, display panel, etc. If the number is not the same as the stored number at step 58, then the thread will not be authenticated.

While the above description is used to convey the invention to those skilled in the art, it is not to limit the scope of the following claims.

What is claimed is:

1. A security thread comprising;
a center insulation thread;
a first conductive thread twisted about said center insulation thread;
a second conductive thread twisted about said center insulation thread so that said second conductive thread is not in physical conduct with said first conductive thread thereby producing a security thread having a unique electromagnetic signature representing the different conductive thread resistance points along the upper portion of the cross-section of said security thread.

2. The invention of claim 1 wherein said plurality of insulators wrapped around said center insulating thread arranged between said first conductive thread and said second conductive thread.

3. The invention of claim 1 wherein said first conductive thread and said second conductive thread are twisted around said center insulating thread at 3.375 turns per inch.

4. The invention of claim 1 including:
a first color carried by said first conductive thread; and,
a second color optically distinguishable from said first color carried by said second conductive thread.

5. The invention of claim 1 wherein said first conductive thread is comprised of conductive material from the group, carbon, gold or silver.

6. The invention of claim 1 including a third conductive thread twisted around said center insulation thread.

7. The invention of claim 6 including a plurality of insulating threads wrapped around said center insulating thread and arranged between said first conductive thread, said second conductive thread, and said third conductive thread.

8. The invention of claim 6 wherein said first conductive thread, said second conductive thread, and said third conductive thread are twisted around said center conductive thread at 3.375 turns per inch.

9. The invention of claim 1 wherein said first conductive thread produces a frequency of greater or equal to 531.44107 KHz.

10. The invention of claim 1 wherein said first conductive thread produces a frequency of less or equal to 531.44092 KHz.

11. A system for authenticating security threads comprising:
an electromagnetic probe for scanning a security thread;
a computer readable medium in communication with said electromagnetic probe;
an authentication number stored in said computer readable medium; and,
a set of computer readable instructions embodied in said computer readable medium for receiving electromagnetical information from said electromagnetic probe, converting said electromagnetic information into a number representing said security thread, comparing said number with said authentication number, and providing notification if said number and said authentication number match.

12. The invention of claim 11 wherein:
said authentication number is stored in an encrypted form; and,
said computer readable instructions include instructions to decrypt said authentication number.

13. The invention of claim 12 wherein said encrypted authentication number is encrypted with a root key of 369.0563.

14. The invention of claim 11 wherein said computer readable instructions include instructions for converting a frequency equal to or greater than 531.44107 KHz to the binary representation one.

15. The invention of claim 11 wherein said computer readable instructions include instructions for converting a frequency equal to or less than 531.44092 KHz to the binary representation zero.
